(19) United States
(12) Patent Application Publication
(10) Pub. No.: US 2011/0154493 A1
(43) Pub. Date: Jun. 23, 2011

(54) METHODS FOR INSPECTING DATA AND DEVICES THEREOF

(75) Inventor: Eric Matthew Thayer, Boonville, NY (US)

(73) Assignee: ASSURED INFORMATION SECURITY, INC., Rome, NY (US)

(21) Appl. No.: 12/973,558

(22) Filed: Dec. 20, 2010

Related U.S. Application Data
(60) Provisional application No. 61/288,057, filed on Dec. 18, 2009.

(51) Int. Cl. G06F 11/00

(52) U.S. Cl. 726/23

(57) ABSTRACT

A method, computer readable medium, and apparatus that inspects data includes isolating retrieved target data within a protected construct with the data inspection processing apparatus. The security software is isolated such that the security software is able to access the target data within the protected construct with the data inspection processing apparatus. The data inspection processing apparatus scans the isolated target data with the isolated security software. The data inspection processing apparatus reports whether one or more security threats have been identified from the scan of the isolated retrieved target data.

This application claims the benefit of U.S. Provisional Patent Application Ser. No. 61/288,057, filed Dec. 18, 2009, which is hereby incorporated by reference in its entirety.

### FIELD

This invention relates to methods for inspecting data and devices thereof.

### BACKGROUND

Daily operations within many facilities, for example in department of defense research laboratories, require particular care to be taken when introducing new software packages or data into a controlled environment. Typically any media entering or leaving a research facility is expected to be scanned for viruses and other malicious content as well as be properly inventoried for reference purposes.

Unfortunately, the people in charge of entry points into such facilities, while skilled in physical security procedures and tactics, are often not trained to identify software viruses, malware, and the various ways which such malicious content can be disguised, masked, or otherwise hidden on the media they are supposed to be screening. While security personnel may be trained to run anti-virus software to scan the incoming media, this process has the potential to expose the scanning system to intended or inadvertent exploitation as well as introduce unacceptable delays to the work cycle.

### SUMMARY

A method for inspecting data includes isolating retrieved target data within a protected construct with a data inspection processing apparatus. The security software is isolated such that the security software is able to access the target data within the protected construct with the data inspection processing apparatus. The data inspection processing apparatus scans the isolated target data with the isolated security software. The data inspection processing apparatus reports whether one or more security threats have been identified from the scan of the isolated retrieved target data.

A non-transitory computer readable medium having stored thereon instructions for methods for data inspection comprising machine executable code which when executed by at least one processor, causes the processor to perform steps including isolating retrieved target data within a protected construct with a data inspection processing apparatus. Security software also is isolated such that the security software is able to access the retrieved target data within the protected construct. The isolated retrieved target data is scanned with the isolated security software. A report is generated on whether one or more security threats have been identified from the scan of the isolated retrieved target data.

A data inspection processing apparatus comprising one or more processors and a memory coupled to the one or more processors which are configured to execute programmed instructions stored in the memory includes isolating retrieved target data within a protected construct with a data inspection processing apparatus. Security software also is isolated such that the security software is able to access the retrieved target data within the protected construct. The isolated retrieved target data is scanned with the isolated security software. A report is generated on whether one or more security threats have been identified from the scan of the isolated retrieved target data.

Accordingly, as illustrated and described herein this technology provides more effective methods and devices for inspecting data. This technology is capable of protecting facilities from malicious software on incoming media, without exposing the computing systems of the facility to the malicious software. Additionally, this technology still enables employees, visitors, and/or other people entering the facility to introduce the software and data required to complete their daily tasks. Further, this technology reduces the amount of specialized training and interaction necessary for security personnel so that they can focus on efficiently completing their main duties.

### BRIEF DESCRIPTION OF THE DRAWINGS

FIG. 1 is a block diagram of an environment with an exemplary data inspection processing apparatus;

FIG. 2 is a flow chart of a method for inspecting data;

FIG. 3 is diagram of an exemplary protected construct for retrieved target data and another exemplary construct for an inventory catalog; and

FIG. 4 is a diagram of another exemplary construct comprising a protective sandbox.

### DETAILED DESCRIPTION

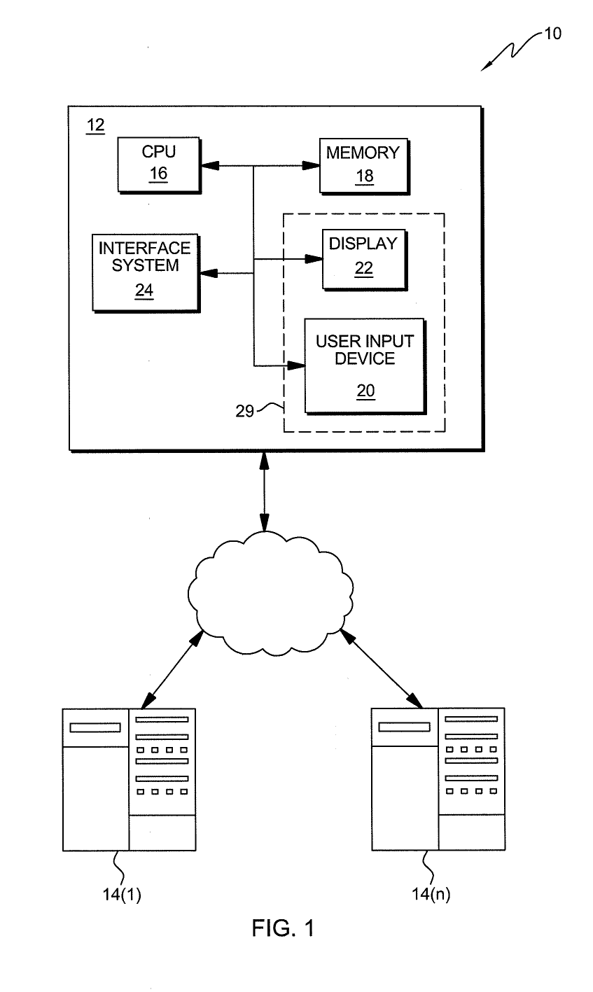

An environment 10 with an exemplary data inspection processing apparatus 12 is illustrated in FIG. 1. This system 10 includes a data inspection processing apparatus 12 and a plurality of data storage devices 14(1)-14(n) coupled together by one or more communication networks, although this system can include other numbers and types of systems, devices, components, and elements in other configurations. The present invention provides a number of advantages including providing more effective methods and apparatuses for inspecting data.

The data inspection processing apparatus 12 includes a central processing unit (CPU) or processor 16, a memory 18, a user input device 20, a display 22, and an interface system 24 which are coupled together by a bus or other link, although other numbers and types of systems, devices, components, and elements in other configurations and locations can be used. The processor 16 in the data inspection processing apparatus 12 executes a program of stored instructions for one or more aspects of the present invention as described and illustrated by way of the exemplary embodiments herein.

The memory 18 in the data inspection processing apparatus 12 stores these programmed instructions for one or more aspects of the present invention as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to processor 16 can be used for the memory in the data inspection processing apparatus 12.

The user input device 20 in the data inspection processing apparatus 12 is used to input requests, selections, and other data, although the user input device could provide other functions and interact with other elements. The user input device can include keypads, touch screens, and/or vocal input processing systems, although other types and numbers of user input devices can be used.

The display 22 in the data inspection processing apparatus 12 is used to show data and information to the user, such as a requested application or other data by way of example only. The display in the data inspection processing apparatus 12 is a computer screen display, although other types and numbers of displays could be used depending on the particular type of mobile device.

The interface system 22 in the data inspection processing apparatus 12 is used to operatively couple and communicate between the data inspection processing apparatus 12 and the data storage devices 14(1)-14(n) via one or more the communications networks, although other types and numbers of communication networks or systems with other types and numbers of connections and configurations can be used. By way of example only, the communications networks can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

Each of the data storage devices 14(1)-14(n) stores data, such as applications, files and directories, although other numbers and types of storage systems which could have other numbers and types of functions and store other data could be used. In this particular example, data storage devices 14(1)-14(n) are shown as data storage servers, although other numbers and types of data storage devices which are internal to or connected or otherwise coupled to the data inspection processing apparatus 12 can be used. By way of example only, one or more of the data storage devices 14(1)-14(n) can comprise a data storage server, CD drive, a DVD drive, a USB hard drive, an IDE hard drive, an SATA hard drive, an ESATA hard drive, an SAS hard drive, a SCSI hard drive, a USB thumb drive, a flash drive, a USB port, and a firewire port. The data storage devices 14(1)-14(n) may or may not have their own separate processing capabilities.

Although an exemplary embodiment of the data inspection processing apparatus 12 and the data storage devices 14(1)-14(n) are described herein, each of these systems could also be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

An exemplary method for inspecting data will now be described with reference to FIGS. 1-4. In step 42, the data inspection processing apparatus 12 is configured to retrieve target data 28 from a data input, such as from one of the data storage devices 14(1)-14(n). The target data 28 may be any type of data, including but not limited to compressed data, image data, document data, presentation data, and virtual machine image data. The target data 28 may be compressed, layered, or encrypted to hide malicious software. Accordingly, in some exemplary embodiments, the data inspection processing apparatus 12 may further be configured to unpack the target data to a lowest data level as part of the data retrieval process in order to allow deep inspection of the data.

In this context, deep data inspection (which may also be referred-to as deep file inspection) by the data inspection processing apparatus 12 is the process of analyzing an unknown piece of data and identifying the file structures within that data. This process is performed by the data inspection processing apparatus 12 by analyzing the characteristics of the piece of data and using alternate mechanisms, such as file header information to identify file types. Complex file types, such as archives or virtual machine disk images, are containers for multiple files and must be deconstructed by the data inspection processing apparatus 12 to their lowest level file container. Each time a file container, archive or other stored element is expanded, the list of files is again analyzed by the data inspection processing apparatus 12 to identify any other file containers until no more can be found. Additionally, deep file inspection by the data inspection processing apparatus 12 is intended to assist in the detection of files created using malicious procedures, such as trojanizing a file by modifying the original file to contain legitimate content, such as malicious content, appended to the end of the file.

Another process commonly used by malware to evade detection by antivirus or anti malware software is referred to as packing Packing is the process of compressing or encoding a program in such a way that is cannot be accessed or analyzed without knowledge of the original packing program, even though it capable of still executing. Traditionally files that cannot be analyzed, such as packed files, are ignored. However, with this technology a failure to identify a file properly by the data inspection processing apparatus 12 is a functional failure and the target data will not be allowed to pass the testing process.

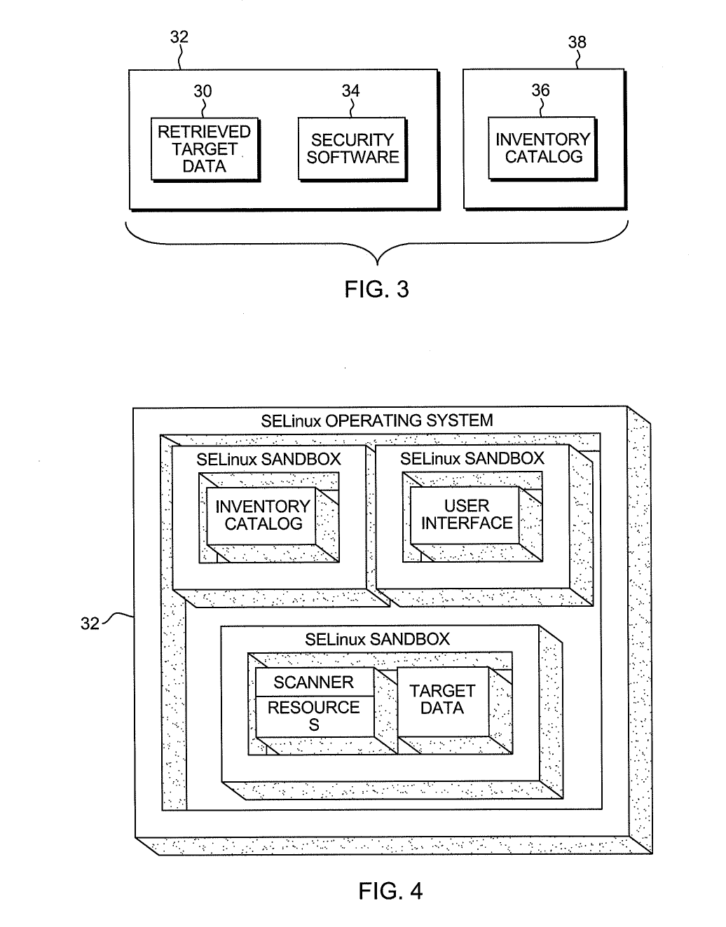

In step 44, the data inspection processing apparatus 12 is configured to isolate the retrieved target data 30 within a protected construct 32 as shown in FIG. 3. Depending on the embodiment, the retrieved target data 30 may be a copy of the target data or it may be the actual target data 28. The protected construct 32 generated by the data inspection processing apparatus 12 is designed to limit the retrieved target data 30 from interacting with the rest of the system hardware, software, or firmware within the data inspection processing apparatus 12 without the knowledge or permission of the data inspection processing apparatus 12. By way of example only, the configuration generated by the data inspection processing apparatus 12 to isolate the retrieved target data 30 within the protected construct 32 may be: (1) a mandatory access control implementation, such as SELinux; (2) a chroot environment; (3) a Windows jail; or (4) a FreeBSD jail. In other exemplary embodiments, where another protected construct 32 includes SELinux, this protected construct 32 may also include one or more SELinux sandboxes.

In step 46, the data inspection processing apparatus 12 also is configured to isolate security software 34 operable by the data inspection processing apparatus 12 so that the security software 34 is able to safely access the target data 30 within the protected construct 32. In some exemplary embodiments, the data inspection processing apparatus 12 may be configured so that the security software 34 is also able to access one or more isolated system files needed by the security software 34. By way of example only, the security software 34 may include, but is not limited to anti-virus scanning software and/or anti-malware scanning software.

In step 48, the data inspection processing apparatus 12 is further configured to scan the isolated target data 30 with the isolated security software 34 within the protected construct 32.

In step 50, the data inspection processing apparatus 12 is configured to report via the display 22 whether one or more security threats have been identified from the scan of the isolated target data 30 using the isolated security software 34 within the protected construct 32.

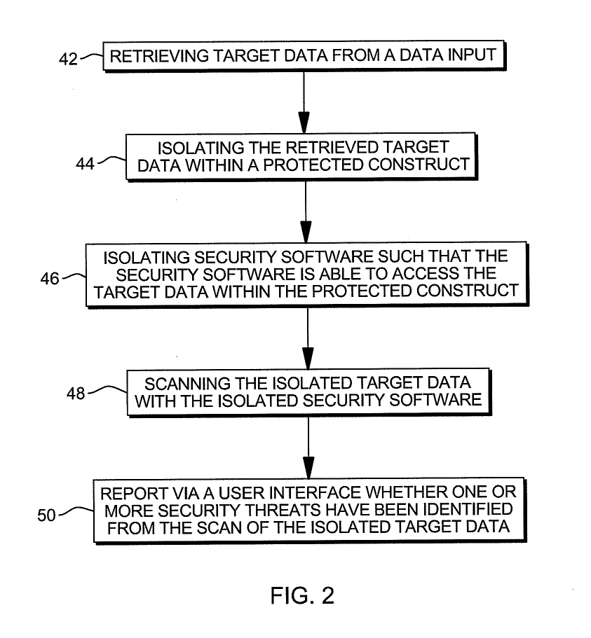

In another exemplary method for inspecting data, the steps illustrated in FIG. 2 and discussed above are the same, except that in step 44 the data inspection processing apparatus 12 is further configured to place the target data 30 within the protected construct at a lowest privilege level. Additionally, in step 46 the data inspection processing apparatus 12 is further configured so the security software 34 is able to access the target data 30 within the protected construct 32 by being granted authority to access the target data 30 at the lowest privilege level.

In another exemplary method for inspecting data, the steps illustrated in FIG. 2 and discussed above are the same, except the data inspection processing apparatus 12 is further configured to update an inventory catalog with information regarding the retrieved target data 30 which can be stored in memory 18, although the inventory catalog can be stored in other locations and manners. Information that could be tracked by the data inspection processing apparatus 12 and kept within the inventory catalog may be information pertinent to the target data 30 being processed.

By way of example only, the type of information which may be stored in the inventory catalog includes one or more of file name, file type, file date, scan date, and information on the user performing the scan. For example, the user performing the scan could be a guard or a person who owns the target data. Information pertaining to the scan, such as the results of the security scans or unknown file types, also could be logged in the inventory catalog.

The data inspection processing apparatus 12 may further be configured to isolate the inventory catalog within yet another protected construct 38 generated by the data inspection processing apparatus 12. The data inspection processing apparatus 12 may further be configured within another different protected construct 29 around one or both of the user input device 20 and the display 22.

In yet another example illustrated in FIG. 4, the data inspection processing apparatus 12 utilizes Security Enhanced (SE) Linux policy and Multilevel Security (MLS) access control mechanisms to place the target data in a least privilege state and create an execution sandbox to minimize system exposure to any malicious code. In this embodiment, the data inspection processing apparatus 12 is configured to retrieve target data and place it at the lowest privilege level. This is accomplished in this example by using SELinux policies and MLS access control mechanisms assigned to the data inspection processing apparatus 12. This embodiment of the data inspection processing apparatus 12 supports most common file systems and the majority of file types that are typically used in a research environment, including compressed files, images, documents, presentations, and virtual machine images. Other embodiments may support fewer or more file types, including files types not listed.

Further in this exemplary embodiment, utilizing SELinux policy the Anti Virus and Anti Malware scanning software are placed in the confines of a protective sandbox and used to analyze the retrieved target data. In this example, the policy limits the scanning security software to accessing only retrieved target data and the required files on the data inspection processing apparatus 12 it is explicitly granted access to. Any additional access attempts to system resources or files are explicitly denied minimizing the chance of system compromise via the scanning security software. Additionally, in this example to further improve overall system security, the user interface comprising a user input device and display and inventory control catalog are also placed within the confines of the protective sandbox.

Accordingly, as illustrated and described herein this technology provides a more effective methods and devices for data inspection. This technology is capable of protecting facilities from malicious software on incoming media, without exposing the computing systems of the facility to the malicious software. Additionally, this technology still enables employees, visitors, and/or other people entering the facility to introduce the software and data required to complete their daily tasks. Further, this technology reduces the amount of specialized training and interaction necessary for security personnel so that they can focus on efficiently completing their main duties.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for inspecting data, the method comprising:
isolating retrieved target data within a protected construct with a data inspection processing apparatus;
isolating security software such that the security software is able to access the retrieved target data within the protected construct with the data inspection processing apparatus;
scanning the isolated retrieved target data with the isolated security software with the data inspection processing apparatus; and
reporting whether one or more security threats have been identified from the scan of the isolated retrieved target data with the data inspection processing apparatus.

2. The method of claim 1 further comprising unpacking the retrieved target data to a lowest data level with the data inspection processing apparatus.

3. The method of claim 1 further comprising:
placing the isolated retrieved target data at a lowest privilege level with the data inspection processing apparatus; and
granting the isolated security software access to the retrieved target data at the lowest privilege level with the data inspection processing apparatus.

4. The method as set forth in claim 1 further comprising:
identifying when one or more files in the isolated retrieved target data is a functional failure with the data inspection processing apparatus; and
generating a determination that the isolated retrieved target data will not pass when the one or more file in the isolated retrieved target data are identified as a functional failure with the data inspection processing apparatus.

5. The method of claim 1, wherein the isolating further comprises isolating the retrieved target data within the protected construct comprising one of a mandatory access control implementation, a chroot environment, a Windows jail, and a FreeBSD jail with the data inspection processing apparatus.

6. The method of claim 1, further comprising updating an inventory catalog with information regarding the retrieved target data with the data inspection processing apparatus.

7. The method as set forth in claim 6 further comprising isolating the inventory catalog within another protected construct with the data inspection processing apparatus.

8. The method as set forth in claim 7 further comprising isolating at least one of a user input device and a display with yet another protected construct with the data inspection processing apparatus.

9. A non-transitory computer readable medium having stored thereon instructions for methods for inspecting data comprising machine executable code which when executed by at least one processor, causes the processor to perform steps comprising:
isolating retrieved target data with the data inspection processing apparatus within a protected construct;
isolating security software such that the security software is able to access the isolated retrieved target data within the protected construct;
scanning the isolated retrieved target data with the isolated security software; and
reporting whether one or more security threats have been identified from the scan of the isolated retrieved target data.

10. The medium of claim 9 further comprising unpacking the retrieved target data to a lowest data level.

11. The medium of claim 9 further comprising:
placing the isolated retrieved target data at a lowest privilege level; and
granting the isolated security software access to the retrieved target data at the lowest privilege level.

12. The medium as set forth in claim 9 further comprising:
identifying when one or more files in the isolated retrieved target data is a functional failure; and
generating a determination that the isolated retrieved target data will not pass when the one or more file in the isolated retrieved target data are identified as a functional failure.

13. The medium of claim 9, wherein the isolating further comprises isolating the retrieved target data within the protected construct comprising one of a mandatory access control implementation, a chroot environment, a Windows jail, and a FreeBSD jail.

14. The medium of claim 9 further comprising updating an inventory catalog with information regarding the retrieved target data.

15. The medium as set forth in claim 14 further comprising isolating the inventory catalog within another protected construct.

16. The medium as set forth in claim 15 further comprising isolating with the data inspection processing apparatus at least one of a user input device and a display with yet another protected construct.

17. A data inspection processing apparatus comprising:
one or more processors; and
a memory coupled to the one or more processors which are configured to execute programmed instructions stored in the memory comprising:
isolating retrieved target data within a protected construct;
isolating security software such that the security software is able to access the isolated retrieved target data within the protected construct;
scanning the isolated retrieved target data with the isolated security software; and
reporting whether one or more security threats have been identified from the scan of the isolated retrieved target data.

18. The apparatus of claim 17 wherein the one or more processors is further configured to execute programmed instructions stored in the memory further comprising unpacking the retrieved target data to a lowest data level.

19. The apparatus of claim 17 wherein the one or more processors is further configured to execute programmed instructions stored in the memory further comprising:
placing the isolated retrieved target data at a lowest privilege level; and
granting the isolated security software access to the retrieved target data at the lowest privilege level.

20. The apparatus as set forth in claim 17 wherein the one or more processors is further configured to execute programmed instructions stored in the memory further comprising:
identifying when one or more files in the isolated retrieved target data is a functional failure; and
generating a determination that the isolated retrieved target data will not pass when the one or more file in the isolated retrieved target data are identified as a functional failure.

21. The apparatus of claim 17, wherein the one or more processors is further configured to execute programmed instructions stored in the memory for the isolating further comprising isolating the retrieved target data within the protected construct comprising one of a mandatory access control implementation, a chroot environment, a Windows jail, and a FreeBSD jail.

22. The apparatus of claim 17 wherein the one or more processors is further configured to execute programmed instructions stored in the memory further comprising updating an inventory catalog with information regarding the retrieved target data.

23. The apparatus as set forth in claim 22 wherein the one or more processors is further configured to execute programmed instructions stored in the memory further comprising isolating the inventory catalog within another protected construct.

24. The apparatus as set forth in claim 23 wherein the one or more processors is further configured to execute programmed instructions stored in the memory further comprising isolating with the data inspection processing apparatus at least one of a user input device and a display with yet another protected construct.
